(19) United States
(12) Patent Application Publication
(10) Pub. No.: US 2015/0070279 A1
(43) Pub. Date: Mar. 12, 2015

(54) MULTI FUNCTION MOUSE DEVICE

(71) Applicant: Primax Electronics Ltd., Taipei (TW)

(72) Inventors: CHIEN-NAN LIN, Taipei (TW); TUN-SHIN WANG, Taipei (TW)

(73) Assignee: Primax Electronics Ltd., Taipei (TW)

(21) Appl. No.: 14/103,314

(22) Filed: Dec. 11, 2013

(30) Foreign Application Priority Data
Sep. 6, 2013 (TW) 102132214

(51) Int. Cl. G06F 3/0354

(52) U.S. Cl. CPC G06F 3/03543
USPC 345/163

(57) ABSTRACT

A multi-function mouse device is in communication with a computer. The multi-function mouse device includes a casing and a mode selection element. The casing has a casing surface. The mode selection element is disposed on the casing surface. When the mode selection element is triggered by a user's finger but the casing is not moved by a user's palm, a predetermined command is executed by the computer. When the mode selection element is triggered by the user's finger but the casing is not moved by a user's palm, another predetermined command corresponding to a motion trajectory of the casing is executed by the computer.

### FIELD OF THE INVENTION

The present invention relates to a mouse device, and more particularly to a multi-function mouse device.

### BACKGROUND OF THE INVENTION

With increasing development of science and technology, multimedia products and computers become essential in our daily lives. In the computer systems, input devices play important roles for communicating the computer host and the user. The widely-used input devices include for example mouse devices, keyboard devices or trackballs. Among these input devices, mouse devices are the most prevailing because they are very easy-to-use. When a mouse device is held by a user's palm, the user may move the mouse to control movement of the cursor shown on the computer screen. In addition, by manipulating the buttons of the mouse device with the user's fingers, the user may click and select a desired icon shown on the computer monitor or execute a corresponding function.

FIG. 1 is a schematic diagram illustrating the connection between a conventional wheel mouse device and a computer system. As shown in FIG. 1, the computer system 2 comprises a computer host 21 and a computer monitor 22. The computer host 21 is in communication with the wheel mouse device 1 and the computer monitor 22. A cursor 221 and a graphic-based window 222 are displayed on the computer monitor 22. The wheel mouse device 1 is used for controlling the cursor 221, so that the computer host 21 executes a corresponding command. The wheel mouse device 1 comprises a casing 10, a left button 11, a right button 12, and a scroll wheel 13. The casing 10 is used for supporting a user's palm. When the casing 10 is moved by the user to result in a displacement amount, the cursor 221 shown on the computer monitor 22 is correspondingly moved by the computer host 21 according to the displacement amount. By clicking the left button 11 or the right button 12, a control signal is issued to the computer host 21. In response to the control signal, the computer host 21 executes a corresponding command. By rotating the scroll wheel 13, the graphic-based window 222 shown on the computer monitor 21 may be scrolled upwardly or downwardly. The basic functions of the wheel mouse device 1 have been described above.

From the above discussions, the conventional wheel mouse device has only the cursor control function when the conventional wheel mouse device is moved by the user. For executing a specified command, the user has to move the mouse device to have the cursor move to a specified computer program icon and then click the icon to execute the specified command.

For solving the above drawbacks, a mouse device capable of executing a special function has been disclosed. The mouse device is equipped with a functional button. After the functional button of the mouse device is pressed down, the computer host executes a corresponding command according to a motion trajectory of the casing. For example, if the casing of the mouse device is moved to a specified distance in the left direction after the functional button is pressed down, a “Backward” function is implemented to allow the graphic-based window (e.g. a web browser) shown on the computer monitor browsing page to go backward to the previous page. The above technologies have been disclosed in for example Taiwanese Patent No. 1406157 and Taiwanese Patent Publication No. 200939077, and are not redundantly described herein.

However, since the multimedia technologies and various application programs are gradually developed in recent years, the interface of the graphic-based window of the computer becomes more complicated and more diversified. Under this circumstance, the functions provided by the above mouse device are gradually insufficient to meet the user's requirements.

Therefore, it is important to increase the functions of the mouse device without the need of additionally installing the functional button. Consequently, the space within the casing of the mouse device can be saved.

### SUMMARY OF THE INVENTION

The present invention provides a multi-function mouse device for providing a predetermined function according to a moving distance and a motion trajectory.

In accordance with an aspect of the present invention, there is provided a multi-function mouse device. The multi-function mouse device is in communication with a computer host for controlling a cursor shown on a computer monitor. The computer monitor is in communication with the computer host. The multi-function mouse device includes a casing, a displacement sensing module, a mode selection element, and a controlling unit. The casing has a casing surface. The displacement sensing module is disposed within the casing. The displacement sensing module generates at least one displacement amount signal in response to movement of the casing. The mode selection element is disposed on the casing surface. When the mode selection element is triggered, an enabling signal is generated. The controlling unit is connected with the displacement sensing module and the mode selection element for receiving the at least one displacement amount signal, thereby judging a motion trajectory of the casing. If the controlling unit judges that the motion trajectory is not larger than a predetermined distance and the enabling signal is received, the controlling unit issues a first predetermined function signal to the computer host, so that a first predetermined command corresponding to the first predetermined function signal is executed by the computer host according to the first predetermined function signal. Whereas, if the controlling unit judges that the motion trajectory is larger than the predetermined distance and the enabling signal is received, the controlling unit issues a second predetermined function signal to the computer host according to the motion trajectory, so that a second predetermined command corresponding to the second predetermined function signal is executed by the computer host according to the second predetermined function signal.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic diagram illustrating the connection between a conventional wheel mouse device and a computer system;

FIG. 2 is a schematic perspective view illustrating the outer appearance of a multi-function mouse device according to a first embodiment of the present invention;

FIG. 3 is a schematic cross-sectional view illustrating the internal structure of the multi-function mouse device of FIG. 2;

FIG. 4 is a schematic diagram illustrating the connection between the multi-function mouse device of FIG. 2 and a computer system;

FIG. 5 is a schematic functional block diagram illustrating the relationship between the multi-function mouse device and the computer system as shown in FIG. 4;

FIG. 6 is a schematic diagram illustrating the use of the multi-function mouse device of FIG. 2 to control the cursor shown on the computer monitor;

FIG. 7 is a schematic diagram illustrating the use of the multi-function mouse device of FIG. 2 in a first operating mode;

FIG. 8 is a schematic diagram illustrating the use of the multi-function mouse device of FIG. 2 in a second operating mode;

FIG. 9 schematically illustrates the motion trajectory of the multi-function mouse device of FIG. 8 in the second operating mode; and

FIG. 10 is a schematic perspective view illustrating the outer appearance of a multi-function mouse device according to a second embodiment of the present invention.

### DETAILED DESCRIPTION OF THE PREFERRED EMBODIMENT

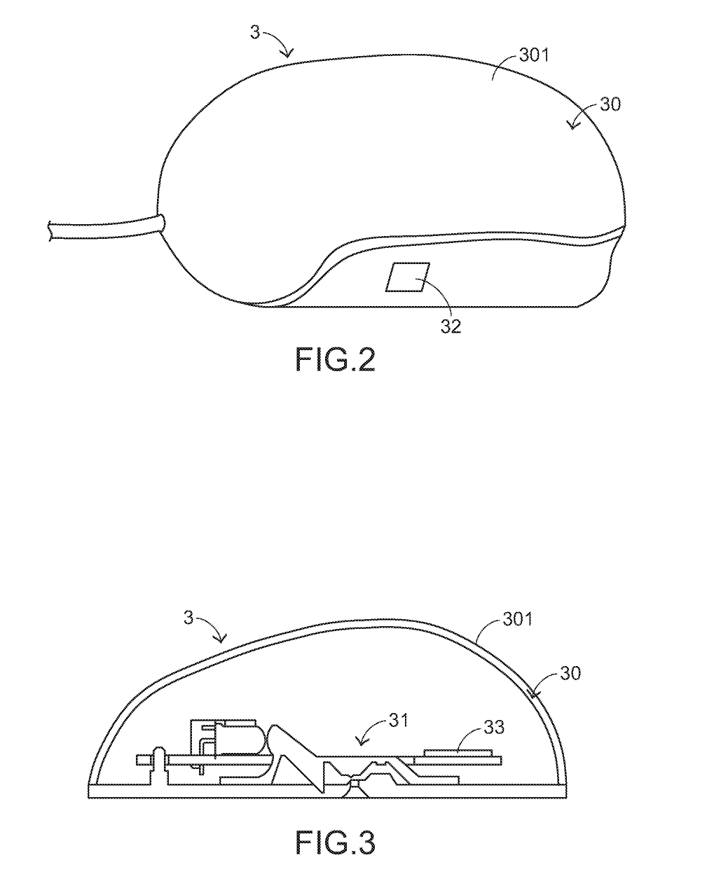

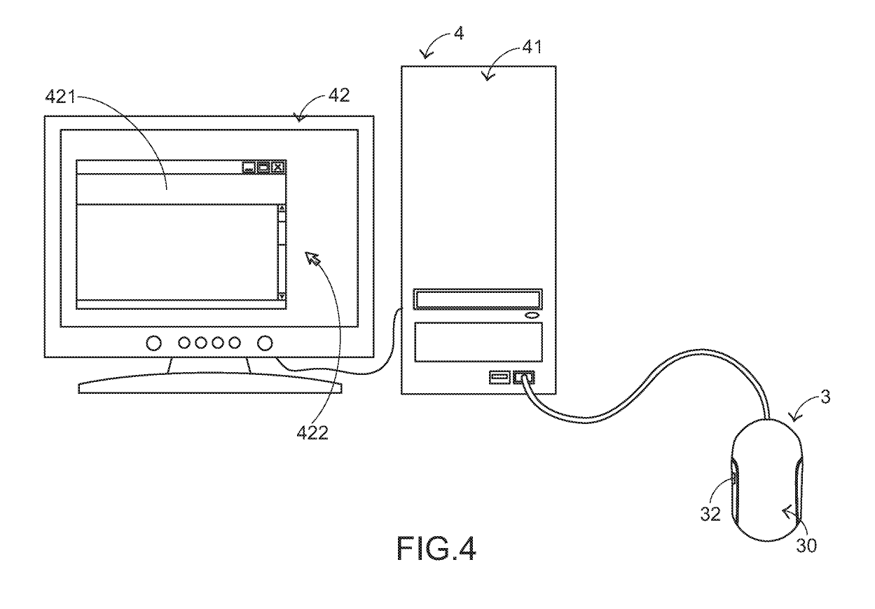

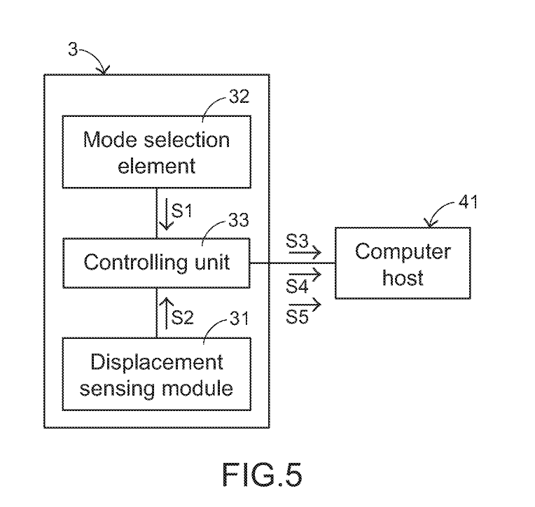

For solving the drawbacks encounter from the prior art, the present invention provides a multi-function mouse device. FIG. 2 is a schematic perspective view illustrating the outer appearance of a multi-function mouse device according to a first embodiment of the present invention. FIG. 3 is a schematic cross-sectional view illustrating the internal structure of the multi-function mouse device of FIG. 2. FIG. 4 is a schematic diagram illustrating the connection between the multi-function mouse device of FIG. 2 and a computer system. FIG. 5 is a schematic functional block diagram illustrating the relationship between the multi-function mouse device and the computer system as shown in FIG. 4.

Please refer to FIGS. 2-5. The multi-function mouse device 3 comprises a casing 30, a displacement sensing module 31, a mode selection element 32, and a controlling unit 33. The casing 30 has a casing surface 301. The mode selection element 32 is disposed on the casing surface 301. When the mode selection element 32 is triggered, an enabling signal S1 is generated. The displacement sensing module 31 is disposed within the casing 30. In response to the movement of the casing 30, a corresponding displacement amount signal S2 is generated. The controlling unit 33 is connected between the mode selection element 32 and the displacement sensing module 31 for receiving the enabling signal S1 and the displacement amount signal S2. In this embodiment, the controlling unit 33 is a microprocessor. Moreover, the mode selection element 32 is a physical button, but is not limited thereto. Alternatively, in some other embodiments, the mode selection element 32 is an optical sensor or a capacitive touchpad.

The computer system 4 comprises a computer host 41 and a computer monitor 42. The computer host 41 is in communication with the multi-function mouse device 3 and the computer monitor 42. A cursor 421 and a graphic-based window 422 are displayed on the computer monitor 42. In this embodiment, the graphic-based window 422 is illustrated by referring to a graphic-based window of a web browser, but is not limited thereto.

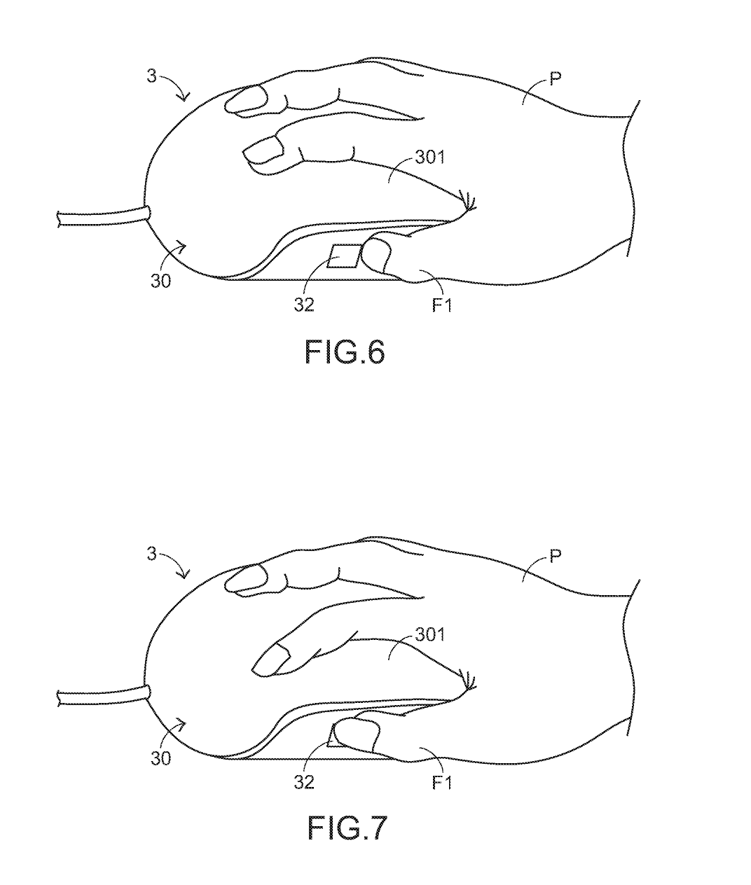

FIG. 6 is a schematic diagram illustrating the use of the multi-function mouse device of FIG. 2 to control the cursor shown on the computer monitor. For operating the multi-function mouse device 3 to control the cursor 421 shown on the computer monitor 42, the user's palm P is firstly supported on the casing surface 301. At the same time, a finger F1 is placed near the mode selection element 32, or the finger F1 is placed on the mode selection element 32 but the mode selection element 32 is not pressed and triggered by the finger F1. Consequently, no enabling signal S1 from the mode selection element 32 is received by the controlling unit 33. When the casing 30 is moved by the user according to the practical requirements, the displacement amount signal S2 corresponding to the motion trajectory of the casing 30 is transmitted from the displacement sensing module 31 to the controlling unit 33. According to the received displacement amount signal S2, the controlling unit 33 can realize the motion trajectory of the casing 30, thereby generating a corresponding cursor displacement signal S3 to the computer host 41. According to the cursor displacement signal S3, the cursor 421 is correspondingly moved by the computer host 41.

FIG. 7 is a schematic diagram illustrating the use of the multi-function mouse device of FIG. 2 in a first operating mode. For operating the multi-function mouse device 3 to allow the computer host 41 to execute a first predetermined command, the user's palm P is firstly supported on the casing surface 301. At the same time, the finger F1 is placed on the mode selection element 32 to press and trigger the mode selection element 32. When the casing 30 is moved and the motion trajectory of the casing 30 is not larger than a predetermined distance, the enabling signal S1 from the mode selection element 32 and the displacement amount signal S2 from the displacement sensing module 31 are received by the controlling unit 33. After the controlling unit 33 judges that the he motion trajectory is not larger than the predetermined distance, the controlling unit 33 issues a first predetermined function signal S4 to the computer host 41. According to the first predetermined function signal S4, a first predetermined command corresponding to the first predetermined function signal S4 is executed by the computer host 41.

In this embodiment, a backspace function is implemented in response to the execution of the first predetermined command, and the predetermined distance is a near-zero distance. Consequently, even if the user presses and triggers the mode selection element 32 of the multi-function mouse device 3 without moving the casing 30, a backspace action is performed on the graphic-based window 422 that is displayed on the computer monitor 42. For example, while keying in the web browser, the backspace action may be performed. However, those skilled in the art will readily observe that numerous modifications and alterations may be made while retaining the teachings of the invention. For example, in a variant example, a delete function is implemented in response to the execution of the first predetermined command.

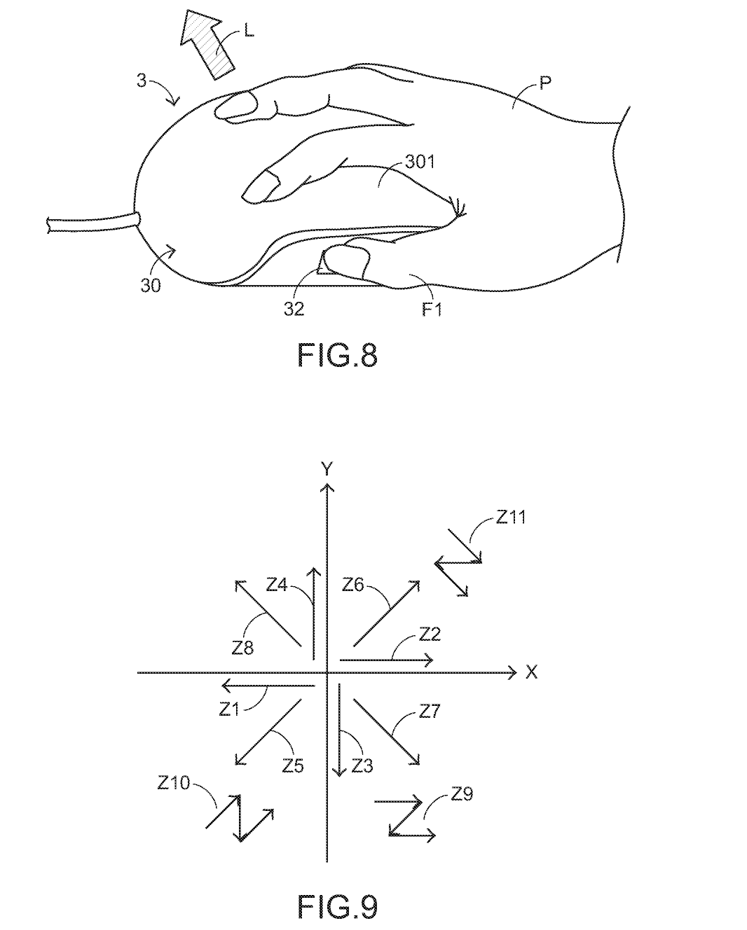

FIG. 8 is a schematic diagram illustrating the use of the multi-function mouse device of FIG. 2 in a second operating mode. For operating the multi-function mouse device 3 to allow the computer host 41 to execute a second predetermined command, the user's palm P is firstly supported on the casing surface 301. At the same time, the first F1 is placed on the mode selection element 32 to press and trigger the mode selection element 32. When the casing 30 is moved along a motion trajectory L, the enabling signal S1 from the mode selection element 32 and the displacement amount signal S2 from the displacement sensing module 31 are received by the controlling unit 33. After the controlling unit 33 judges the type of the motion trajectory L, the controlling unit 33 issues a second predetermined function signal S5 corresponding to the motion trajectory L to the computer host 41.

FIG. 9 schematically illustrates the motion trajectory of the multi-function mouse device of FIG. 8 in the second operating mode. The motion trajectory is a linear motion trajectory in an X-axis direction, a linear motion trajectory in a Y-axis direction, a linear motion trajectory in a specified direction between the X-axis direction and the Y-axis direction, or a letter-shaped motion trajectory. Moreover, each motion trajectory is correlated with a corresponding predetermined command.

If a single displacement amount signal including only an X-axis direction moving vector is received by the controlling unit 33 in response to the movement of the casing 30 and a magnitude of the X-axis direction moving vector is higher than a first threshold value, the controlling unit 33 judges that the motion trajectory of the casing 30 is the linear motion trajectory in the X-axis direction. For example, the linear motion trajectory in the X-axis direction includes a motion trajectory Z1 or a motion trajectory Z2, wherein the motion trajectory Z1 and the motion trajectory Z2 are opposed to each other. In this embodiment, if the controlling unit 33 judges that the motion trajectory of the casing 30 is the motion trajectory Z1, the predetermined command is executed by the computer host 41 to implement a “Backward” function of a web browser. In addition, if the controlling unit 33 judges that the motion trajectory of the casing 30 is the motion trajectory Z2, the predetermined command is executed by the computer host 41 to implement a “Forward” function of the web browser. However, those skilled in the art will readily observe that numerous modifications and alterations may be made while retaining the teachings of the invention.

Moreover, if a single displacement amount signal including only a Y-axis direction moving vector is received by the controlling unit 33 in response to the movement of the casing 30 and a magnitude of the Y-axis direction moving vector is higher than a second threshold value, the controlling unit 33 judges that the motion trajectory of the casing 30 is the linear motion trajectory in the Y-axis direction. For example, the linear motion trajectory in the Y-axis direction includes a motion trajectory Z3 or a motion trajectory Z4, wherein the motion trajectory Z3 and the motion trajectory Z4 are opposed to each other. In this embodiment, if the controlling unit 33 judges that the motion trajectory of the casing 30 is the motion trajectory Z3, the predetermined command is executed by the computer host 41 to implement a function of opening a web browser software (e.g. an Internet Explorer software). In addition, if the controlling unit 33 judges that the motion trajectory of the casing 30 is the motion trajectory Z3, the predetermined command is executed by the computer host 41 to implement a screen-locking function. However, those skilled in the art will readily observe that numerous modifications and alterations may be made while retaining the teachings of the invention.

If a single displacement amount signal including an X-axis direction moving vector and a Y-axis direction moving vector is received by the controlling unit 33 in response to the movement of the casing 30 and a magnitude of the X-axis direction moving vector is higher than the first threshold value and a magnitude of the Y-axis direction moving vector is higher than the second threshold value, the controlling unit 33 judges that the motion trajectory of the casing 30 is the linear motion trajectory in the specified direction between the X-axis direction and the Y-axis direction. For example, the linear motion trajectory in the specified direction between the X-axis direction and the Y-axis direction includes a motion trajectory Z5, a motion trajectory Z6, a motion trajectory Z7 or a motion trajectory Z8.

For example, if the controlling unit 33 judges that the motion trajectory of the casing 30 is the motion trajectory Z5, the predetermined command is executed by the computer host 41 to implement a zooming out function. Moreover, if the controlling unit 33 judges that the motion trajectory of the casing 30 is the motion trajectory Z6, the predetermined command is executed by the computer host 41 to implement a zooming in function. Moreover, if the controlling unit 33 judges that the motion trajectory of the casing 30 is the motion trajectory Z7, the predetermined command is executed by the computer host 41 to implement a function of closing an application program (e.g. a function of closing an Internet Explorer software). Moreover, if the controlling unit 33 judges that the motion trajectory of the casing 30 is the motion trajectory Z8, the predetermined command is executed by the computer host 41 to implement a CapsLock function. However, those skilled in the art will readily observe that numerous modifications and alterations may be made while retaining the teachings of the invention.

Moreover, plural displacement amount signals (e.g. a first displacement amount signal, a second displacement amount signal and a third displacement amount signal) may be sequentially received by the controlling unit 33 in response to the movement of the casing 30. If the X-axis (Y-axis) direction moving vector of the second displacement amount signal is opposed to the X-axis (Y-axis) direction moving vector of the first displacement amount signal and the X-axis (Y-axis) direction moving vector of the third displacement amount signal, and if the magnitude of the X-axis (Y-axis) direction moving vector of the first displacement amount signal, the magnitude of the X-axis (Y-axis) direction moving vector of the second displacement amount signal and the magnitude of the X-axis (Y-axis) direction moving vector of the third displacement amount signal are all higher than a predetermined threshold value, the controlling unit 33 judges that the motion trajectory of the casing 30 is a reciprocating motion trajectory (a Z letter-shaped motion trajectory). For example, the reciprocating motion trajectory includes a motion trajectory Z9, a motion trajectory Z10 or a motion trajectory Z11. In this embodiment, if the controlling unit 33 judges that the motion trajectory of the casing 30 is the reciprocating motion trajectory, the predetermined command is executed by the computer host 41 to implement an Enter function. However, those skilled in the art will readily observe that numerous modifications and alterations may be made while retaining the teachings of the invention.

By the way, when the casing 30 is moved, the casing 30 is usually unable to be accurately moved in the linear direction. That is, the motion trajectory of the casing 30 may be slightly shifted. Preferably, after the magnitude of the X-axis direction moving vector and the magnitude of the Y-axis direction moving vector of the received displacement amount signal are analyzed by the controlling unit 33 of the multi-function mouse device 3, the controlling unit 33 can realize the anticipated motion trajectory of the casing 30 according to the proportion of the magnitude of the X-axis direction moving vector to the magnitude of the Y-axis direction moving vector. For example, if the magnitude of the X-axis direction moving vector and the magnitude of the Y-axis direction moving vector of the displacement amount signal received by the controlling unit 33 are 10 mm and 5 mm, respectively, the controlling unit 33 may judge that the displacement amount signal including only the X-axis direction moving vector is received. Consequently, the shifted motion trajectory of the casing 30 will not cause erroneous operation of the multi-function mouse device 3.

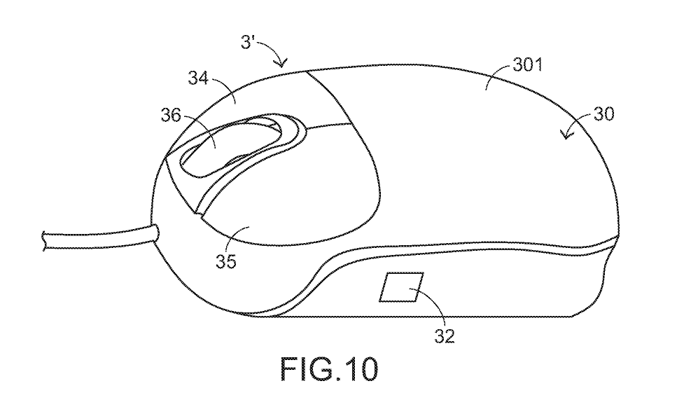

FIG. 10 is a schematic perspective view illustrating the outer appearance of a multi-function mouse device according to a second embodiment of the present invention. In comparison with the multi-function mouse device of the first embodiment, the multi-function mouse device 3′ of this embodiment further comprises a first button 34, a second button 35, and a scroll wheel 36. The first button 34 and the second button 35 are disposed on the casing surface 301, and arranged side-by-side. The scroll wheel 36 is protruded out of the casing surface 301, and arranged between the first button 34 and the second button 35. By clicking the first button 34 or the second button 35, a corresponding control signal is generated. According to the control signal, a corresponding command is executed by the computer host 41. By rotating the scroll wheel 36, the graphic-based window 422 displayed on the computer monitor 42 is scrolled upwardly or downwardly. The structures and functions of the other components of the multi-function mouse device 3′ of this embodiment are substantially identical to those of the first embodiment, and are not redundantly described herein.

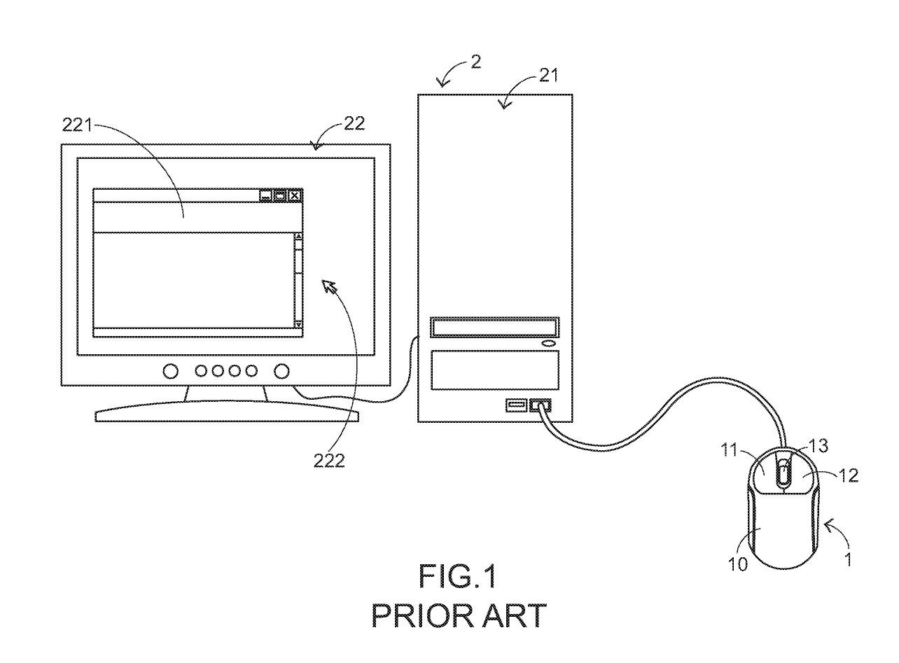

From the above descriptions, by judging whether the motion trajectory of the casing 30 reaches the predetermined distance after the mode selection element 32 is triggered, the controlling unit 33 may determine whether the operating mode of the multi-function mouse device 3 or 3′ needs to be switched. In comparison with the conventional mouse device of FIG. 1 with the functional button, which is equivalent to the mode selection element 32, the multi-function mouse device 3 or 3′ of the present invention can provide more functions without the need of installing an additional physical button. In other words, the multi-function mouse device of the present invention has enhanced industrial usefulness.

Moreover, since a small memory space is required to store various predetermined moving trajectories and corresponding predetermined commands, the predetermined moving trajectories and the corresponding predetermined commands may be stored in a memory of the controlling unit 33. Consequently, the multi-function mouse device can provide various functions without the need of installing a driver in the computer host 41.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A multi-function mouse device in communication with a computer host for controlling a cursor shown on a computer monitor, the computer monitor being in communication with the computer host, the multi-function mouse device comprising:
a casing having a casing surface;
a displacement sensing module disposed within the casing, wherein the displacement sensing module generates at least one displacement amount signal in response to movement of the casing;
a mode selection element disposed on the casing surface, wherein when the mode selection element is triggered, an enabling signal is generated; and
a controlling unit connected with the displacement sensing module and the mode selection element for receiving the at least one displacement amount signal, thereby judging a motion trajectory of the casing,
wherein if the controlling unit judges that the motion trajectory is not larger than a predetermined distance and the enabling signal is received, the controlling unit issues a first predetermined function signal to the computer host, so that a first predetermined command corresponding to the first predetermined function signal is executed by the computer host according to the first predetermined function signal, wherein if the controlling unit judges that the motion trajectory is larger than the predetermined distance and the enabling signal is received, the controlling unit issues a second predetermined function signal to the computer host according to the motion trajectory, so that a second predetermined command corresponding to the second predetermined function signal is executed by the computer host according to the second predetermined function signal.

2. The multi-function mouse device according to claim 1, wherein the mode selection element is a physical button, an optical sensor or a capacitive touchpad

3. The multi-function mouse device according to claim 1, wherein if the enabling signal is not received by the controlling unit, the controlling unit issues a cursor displacement signal to the computer host according to the motion trajectory, wherein according to the cursor displacement signal, the cursor is correspondingly moved by the computer host.

4. The multi-function mouse device according to claim 1, wherein motion trajectory is a linear motion trajectory in an X-axis direction, a linear motion trajectory in a Y-axis direction, a linear motion trajectory in a specified direction between the X-axis direction and the Y-axis direction, or a letter-shaped motion trajectory.

5. The multi-function mouse device according to claim 4, wherein the at least one displacement amount signal is a single displacement amount signal, wherein if the single displacement amount signal includes only an X-axis direction moving vector and a magnitude of the X-axis direction moving vector is higher than a first threshold value, the controlling unit judges that the motion trajectory of the casing is the linear motion trajectory in the X-axis direction, wherein if the single displacement amount signal includes only a Y-axis direction moving vector and a magnitude of the Y-axis direction moving vector is higher than a second threshold value, the controlling unit judges that the motion trajectory of the casing is the linear motion trajectory in the Y-axis direction.

6. The multi-function mouse device according to claim 4, wherein the at least one displacement amount signal is a single displacement amount signal, wherein if the single displacement amount signal includes an X-axis direction moving vector and a Y-axis direction moving vector and a magnitude of the X-axis direction moving vector is higher than a first threshold value and a magnitude of the Y-axis direction moving vector is higher than a second threshold value, the controlling unit judges that the motion trajectory of the casing is the linear motion trajectory in the specified direction between the X-axis direction and the Y-axis direction.

7. The multi-function mouse device according to claim 4, wherein the at least one displacement amount signal comprises a first displacement amount signal, a second displacement amount signal and a third displacement amount signal, and the first displacement amount signal, the second displacement amount signal and the third displacement amount signal are sequentially received by the displacement sensing module, wherein if an X-axis direction moving vector of the second displacement amount signal is opposed to an X-axis direction moving vector of the first displacement amount signal and an X-axis direction moving vector of the third displacement amount signal and a magnitude of the X-axis direction moving vector of the first displacement amount signal, a magnitude of the X-axis direction moving vector of the second displacement amount signal and a magnitude of the X-axis direction moving vector of the third displacement amount signal are all higher than a predetermined threshold value, the controlling unit judges that the motion trajectory of the casing is a reciprocating motion trajectory.

8. The multi-function mouse device according to claim 1, wherein when the first predetermined command is executed, a backspace function or a delete function is implemented.

9. The multi-function mouse device according to claim 1, wherein when the second predetermined command is executed, a zooming in function, a zooming out function, a web browser software opening function, a web browser “Backward” function, a web browser “Forward” function, a screen-locking function or an application program closing function is implemented.

10. The multi-function mouse device according to claim 1, further comprising a first button and a second button, wherein the first button and the second button are disposed on the casing surface and arranged side-by-side.

11. The multi-function mouse device according to claim 10, further comprising a scroll wheel, wherein the scroll wheel is protruded out of the casing surface, wherein when the scroll wheel is rotated, a scrolling signal is generated.

12. The multi-function mouse device according to claim 11, wherein the first button is a left button, the second button is a right button, and the scroll wheel is arranged between the first button and the second button.
